(19) United States
(12) Patent Application Publication
(10) Pub. No.: US 2014/0119448 A1
(43) Pub. Date: May 1, 2014

(54) MOVING IMAGE ENCODING APPARATUS, IMAGE CAPTURING APPARATUS, AND METHOD OF CONTROLLING MOVING IMAGE ENCODING APPARATUS

(71) Applicant: CANON KABUSHIKI KAISHA, Tokyo (JP)

(72) Inventor: Hiroaki Endo, Hachioji-shi (JP)

(73) Assignee: CANON KABUSHIKI KAISHA, Tokyo (JP)

(21) Appl. No.: 14/037,780

(22) Filed: Sep. 26, 2013

(30) Foreign Application Priority Data
Oct. 31, 2012 (JP) 2012-241104

(51) Int. Cl. H04N 7/36

(52) U.S. Cl. CPC H04N 19/00696
USPC 375/240.16

(57) ABSTRACT

A moving image encoding apparatus that supports a plurality of image formats is provided. A format conversion unit converts a format of moving image data. A determination unit determines a prediction mode of intra-frame prediction encoding based on the converted moving image data. An encoding unit performs intra-frame prediction encoding on the moving image data acquired from a memory unit using the determined prediction mode. The determination unit supports moving image data in a predetermined format having a predetermined ratio of the luminance component and the color difference components. The format conversion unit, when the format of the moving image data acquired from the memory unit differs from the predetermined format, converts the format of the moving image data acquired from the memory unit into the predetermined format.

### BACKGROUND OF THE INVENTION

1. Field of the Invention

The present invention relates to a moving image encoding apparatus, an image capturing apparatus, and a method of controlling the moving image encoding apparatus.

2. Description of the Related Art

Heretofore, digital camcorders are well known as moving image recording apparatuses with built-in camera that capture a subject, compress and encode moving image data obtained through image capture, and record the moving image data that has been compressed and encoded. As for the compression encoding method, H.264 which enables compression at a high compression ratio using intra-frame prediction or inter-frame motion prediction is generally used.

A standardized format called 4:2:0 format exists as an input image format for such a compression encoding method. 4:2:0 format is a format in which color moving image data such as RGB moving image data is converted to a luminance component (Y) and two color difference components (Cb, Cr), and the number of samples in the color difference components is reduced to half of the luminance component in both the horizontal and vertical directions. Given that the visibility of the color difference components drops compared with the luminance component, conventionally 4:2:0 format has mainly been used. Since the color difference components are down-sampled before encoding when using 4:2:0 format, the information amount of the moving image data to be encoded is reduced.

4:2:2 format in which the color difference components are down-sampled by half in the horizontal direction only is also sometimes used for business- oriented video such as broadcast material video. Furthermore, development of encoding methods that encode the color difference components at the same number of samples as the luminance component without down-sampling is also progressing with the higher resolution and smoother gradation of displays in recent years. The format in which the number of samples in the color difference components is the same as the luminance component is called 4:4:4 format.

With encoding of moving image data in 4:2:0 format, information for motion compensation prediction is multiplexed only for the luminance component, and motion compensation is performed on the color difference components using the information of the luminance component. This arises from the fact that with 4:2:0 format most of the image information is concentrated in the luminance component, and also because the color difference components are characterized by having a lower visibility of distortion compared with the luminosity signal and contributing little to video reproducibility.

In relation to information for intra-frame prediction, to encode moving image data in 4:2:0 format, information for the luminance component is multiplexed, and, with regard to the color difference components, information common to both color difference components is multiplexed. This also arises from the fact that with 4:2:0 format the color difference components are characterized by having a low visibility of distortion and contributing little to video reproducibility compared with the luminance component, similarly to the abovementioned case of motion compensation prediction.

On the other hand, since the three components have comparable amounts of image information in 4:4:4 format, an encoding method other than an encoding method that is premised on the image information depending largely on one component, such as with 4:2:0 format, is desirable. Japanese Patent Laid-Open No. 2010-45853 discloses an encoding method that supports 4:4:4 format.

According to common compression encoding technology for compressing and encoding moving image data, processing for predicting pixels within the same frame, called intra-frame prediction (intra prediction), is performed. Usually, with intra prediction processing, optimal values of the differences of pixel values are calculated through comparison of pixels in multiple directions. Accordingly, when implementing intra prediction in a moving image encoding apparatus, the processing load required for the computations in a prediction mode needs to be taken into consideration.

Incidentally, in order to support the three image formats 4:2:0, 4:2:2 and 4:4:4, intra prediction mode decision circuits respectively corresponding to the image formats are required. Accordingly, there is a problem in that configuring a moving image encoding apparatus to support a plurality of image formats increases the computational load and therefore the circuit size.

### SUMMARY OF THE INVENTION

The present invention was made in view of such situations, and provides technology for configuring a moving image encoding apparatus to support a plurality of image formats while suppressing an increase in circuit size.

According to a first aspect of the present invention, there is provided a moving image encoding apparatus that supports a plurality of image formats, comprising: a memory unit configured to temporarily store moving image data; a format conversion unit configured to convert a format of moving image data acquired from the memory unit, the format relating to a ratio of a luminance component and color difference components; a determination unit configured to determine a prediction mode of intra-frame prediction encoding based on the converted moving image data; and an encoding unit configured to perform intra-frame prediction encoding on the moving image data acquired from the memory unit using the determined prediction mode, wherein the determination unit supports moving image data in a predetermined format having a predetermined ratio of the luminance component and the color difference components, and the format conversion unit, when the format of the moving image data acquired from the memory unit differs from the predetermined format, converts the format of the moving image data acquired from the memory unit into the predetermined format.

According to a second aspect of the present invention, there is provided an image capturing apparatus comprising: an image capturing unit configured to generate moving image data; and the moving image encoding apparatus according to the moving image encoding apparatus as described above.

According to a third aspect of the present invention, there is provided a method of controlling a moving image encoding apparatus that supports a plurality of image formats and has a memory unit configured to temporarily store moving image data, comprising: a format conversion step of converting a format of moving image data acquired from the memory unit, the format relating to a ratio of a luminance component and color difference components; a determination step of determining a prediction mode of intra-frame prediction encoding based on the converted moving image data; and an encoding step of performing intra-frame prediction encoding on the moving image data acquired from the memory unit using the determined prediction mode, wherein the determination step supports moving image data in a predetermined format having a predetermined ratio of the luminance component and the color difference components, and in the format conversion step, when the format of the moving image data acquired from the memory unit differs from the predetermined format, the format of the moving image data acquired from the memory unit is converted into the predetermined format.

Further features of the present invention will become apparent from the following description of exemplary embodiments with reference to the attached drawings.

### BRIEF DESCRIPTION OF THE DRAWINGS

FIG. 1 is a block diagram showing a configuration of a moving image encoding apparatus 100 according to a first embodiment.

FIGS. 2A to 2D are diagrams illustrating a prediction mode of intra prediction encoding.

FIG. 3 is a flowchart showing operations of an intra prediction mode determination unit 104.

FIG. 4 is a block diagram showing a configuration of a moving image encoding apparatus 400 according to a second embodiment.

### DESCRIPTION OF THE EMBODIMENTS

Embodiments of the present invention will now be described with reference to the attached drawings. It should be noted that the technical scope of the present invention is defined by the claims, and is not limited by any of the embodiments described below. In addition, not all combinations of the features described in the embodiments are necessarily required for realizing the present invention.

### First Embodiment

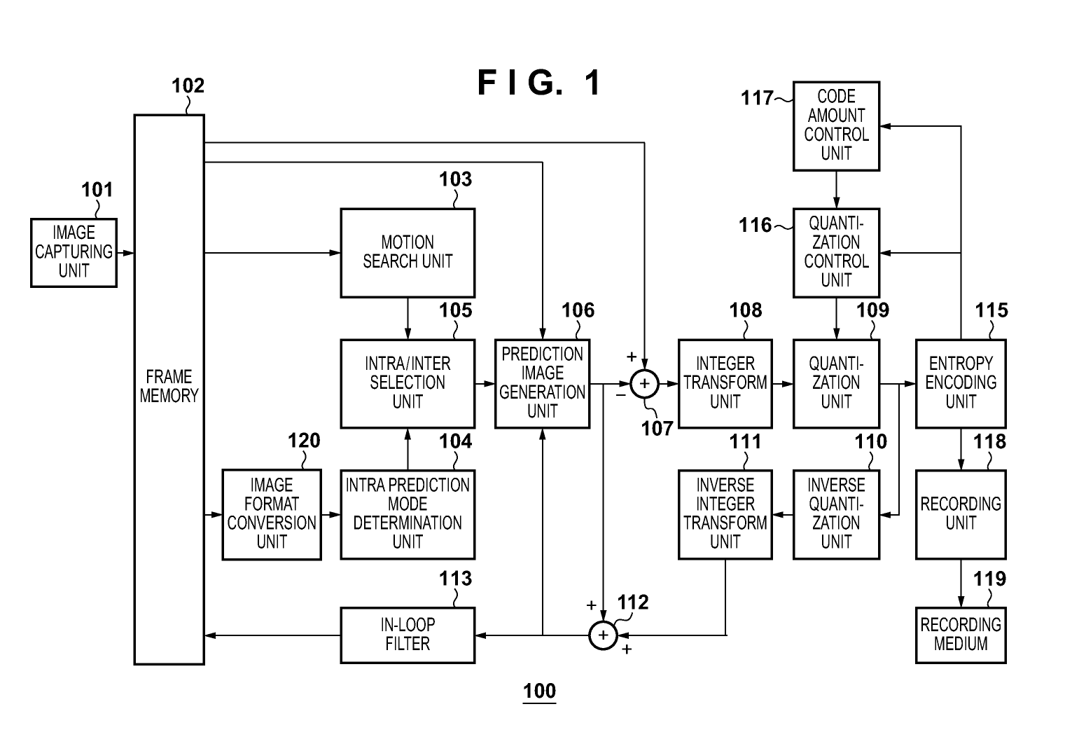

FIG. 1 is a block diagram showing a configuration of a moving image encoding apparatus 100 according to the first embodiment. In FIG. 1, the moving image encoding apparatus 100 is shown as an image capturing apparatus provided with an image capturing unit 101 that includes a lens, an image capturing sensor and the like, although the image capturing unit 101 is not an essential constituent element. The moving image encoding apparatus 100 is provided with a frame memory 102 that temporarily stores moving image data generated by the image capturing unit 101, a motion search unit 103 that searches for motion vectors, and an intra prediction mode determination unit 104 that determines the prediction mode of intra prediction (intra-frame prediction). The moving image encoding apparatus 100 is also provided with an image format conversion unit 120 that converts the image format, an intra/inter selection unit 105 that selects one of inter prediction and intra prediction, and a predicted image generation unit 106. The moving image encoding apparatus 100 is also provided with a subtractor 107, an integer transform unit 108, a quantization unit 109, an inverse quantization unit 110, an inverse integer transform unit 111, an adder 112, and an in-loop filter 113. The moving image encoding apparatus 100 is also provided with an entropy encoding unit 115, a quantization control unit 116, a code amount control unit 117, and a recording unit 118. A recording medium 119 can be mounted in the recording unit 118.

Moving image data generated by the image capturing unit 101 is sequentially stored in an area for input images in the frame memory 102. The moving image encoding apparatus 100 supports a plurality of image formats having different ratios of the luminance component and the color difference components, and is configured so as to enable a user to select the image format of an image to be encoded. In the present embodiment, the moving image encoding apparatus 100 is assumed to support the three image formats 4:2:0, 4:2:2 and 4:4:4. That is, the user is able to select a desired format from among a format whose Y:Cb:Cr ratio is 4:2:0, a format whose Y:Cb:Cr ratio is 4:2:2, and a format whose Y:Cb:Cr ratio is 4:4:4. Moving image data is stored in the frame memory 102 in the image format selected by the user.

The motion search unit 103 reads out the image data of the block to be encoded and the image data of a motion search range in a reference frame from the frame memory 102. The motion search unit 103 then determines a location having a high correlation as a motion vector through block matching between the image data within the search range and the image data of the block to be encoded, and outputs the result to the intra/inter selection unit 105.

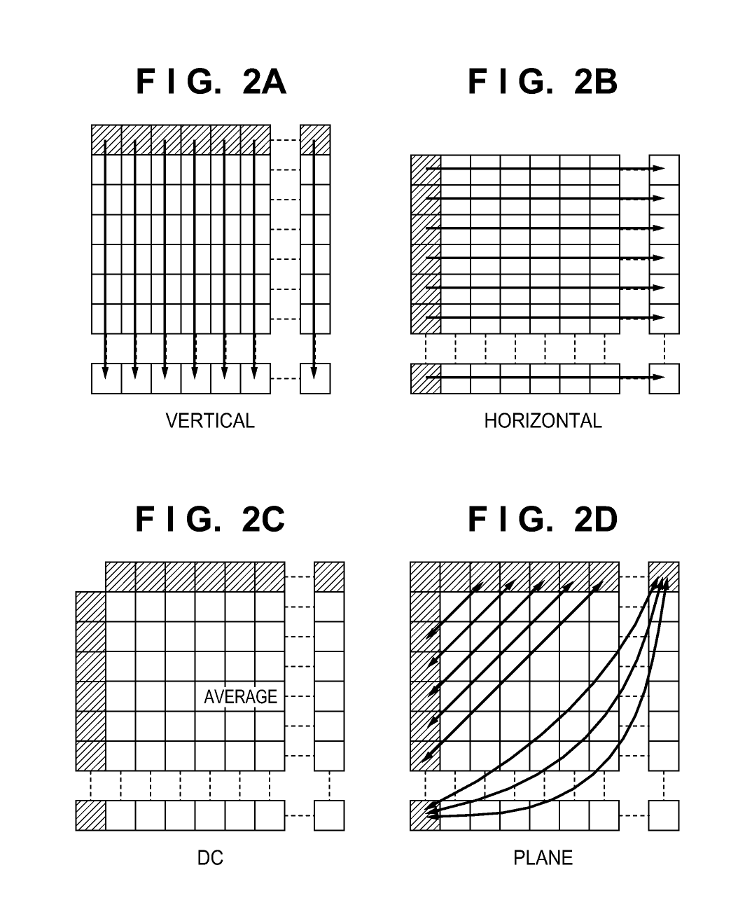

The intra prediction mode determination unit 104 determines the prediction mode of intra-frame prediction encoding (intra prediction encoding). In the present embodiment, the intra prediction mode determination unit 104 selects the prediction mode from among a plurality of prediction modes such as shown in FIGS. 2A to 2D. In FIGS. 2A to 2D, each square indicates one pixel, with the white squares indicating the pixels of the block to be encoded, and the hatched squares indicating neighboring pixels of the block to be encoded. In each intra prediction mode, a predicted image is generated by using the pixel values of neighboring pixels of the block to be encoded in the direction of the arrows. In the vertical prediction mode of FIG. 2A, the predicted image is generated using adjacent pixels above the block to be encoded. In the horizontal prediction mode of FIG. 2B, the predicted image is generated using adjacent pixel to the left of the block to be encoded. In the DC prediction mode of FIG. 2C, the average value of the values of neighboring pixels of the block to be encoded is used as the value of all of the pixels of the predicted image. In the plane prediction mode of FIG. 2D, the predicted image is generated by performing a computation for each pixel of the block to be encoded using the values of a plurality of pixels adjacent to the block to be encoded. Note that the types of intra prediction mode are not limited to those shown in FIGS. 2A to 2D.

The intra prediction mode determination unit 104 supports moving image data of predetermined formats having predetermined ratios of the luminance component and the color difference components. As a specific example, in the present embodiment, the intra prediction mode determination unit 104 is assumed to have a configuration that supports only moving image data in 4:2:0 format.

The intra prediction mode determination unit 104 reads out the image data of the block to be encoded that is stored in the frame memory 102, via the image format conversion unit 120, as image data in 4:2:0 format. Similarly, the intra prediction mode determination unit 104 reads out image data neighboring the block to be encoded that is stored in the frame memory 102, via the image format conversion unit 120, as image data in 4:2:0 format.

The image format conversion unit 120 converts the image format of the moving image data into the image format supported by the intra prediction mode determination unit 104. Specifically, when the input moving image data is in 4:2:2 format, the image format conversion unit 120 generates moving image data in 4:2:0 format by reducing the color difference components by half in the vertical direction. Also, when the input moving image data is in 4:4:4 format, the image format conversion unit 120 generates moving image data in 4:2:0 format by respectively reducing the color difference components by half in both the horizontal and vertical directions. Also, when the input moving image data is in 4:2:0 format, processing for reducing the color difference components is not performed.

Note that although a configuration has been illustrated in which the predetermined format is 4:2:0 format, the intra prediction mode determination unit 104 may support moving image data in 4:2:2 format, for example, instead of 4:2:0 format. In this case, the image format conversion unit 120 converts moving image data in 4:2:0 format or 4:4:4 format that differs from 4:2:2 format into moving image data in 4:2:2 format.

The intra prediction mode determination unit 104 generates a predicted image corresponding to each of the plurality of intra prediction modes using neighboring image data of the block to be encoded. The intra prediction mode determination unit 104 then calculates, for each of the plurality of intra prediction modes, an evaluation value representing the correlation between the block to be encoded and the predicted image. The evaluation value is, for example, the sum of the absolute values of differences between the pixel values of the block to be encoded and the predicted image, with the correlation increasing as the evaluation value decreases. Note that the method of calculating the evaluation value is not limited thereto. The intra prediction mode determination unit 104 determines an intra prediction mode for the luminance component and an intra prediction mode for the color difference components that is common to both color difference components.

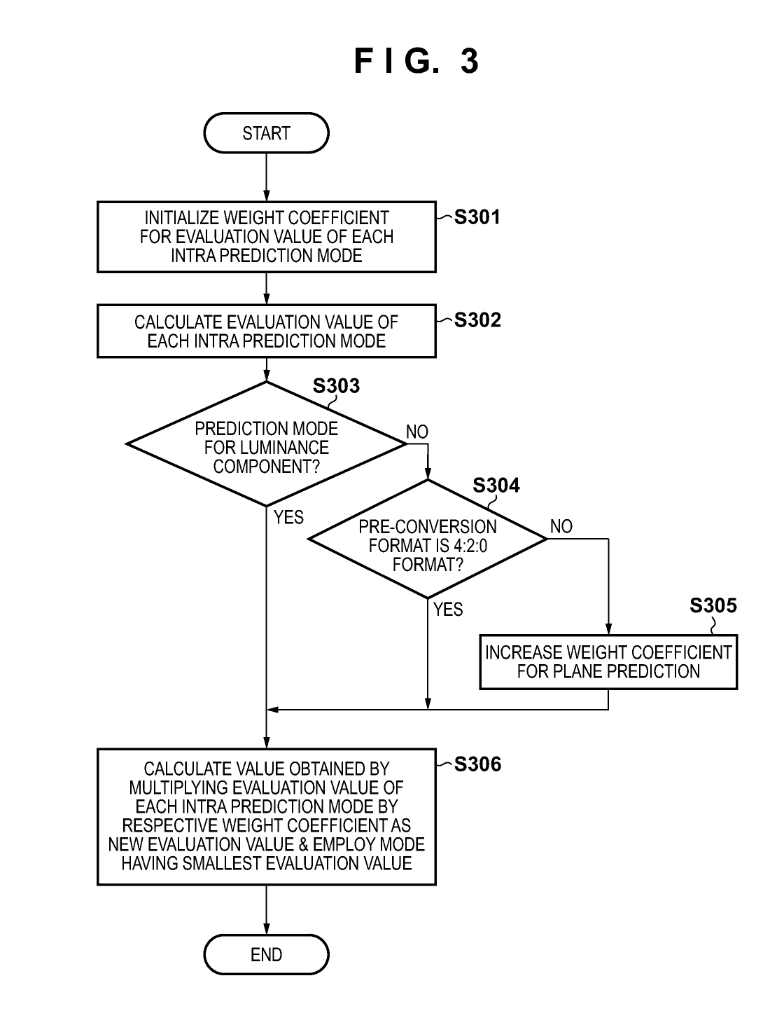

Next, operations of the intra prediction mode determination unit 104 will be described, with reference to the flowchart of FIG. 3. At step S301, the intra prediction mode determination unit 104 initializes the weight coefficient for the evaluation value of each intra prediction mode. The initial value may be determined in advance or may be determined adaptively depending on picture type, image features or the like.

At step S302, the intra prediction mode determination unit 104, as mentioned above, generates a predicted image corresponding to each intra prediction mode, and calculates the evaluation value of each intra prediction mode. At step S303, the intra prediction mode determination unit 104 determines whether the processing being executed is processing for determining the prediction mode for the luminance component. In the case of being processing for determining the prediction mode for the luminance component, the processing proceeds to step S306, and if this is not the case, the processing proceeds to step S304.

At step S304, the intra prediction mode determination unit 104 determines whether the image format selected by the user (i.e., image format before conversion by the image format conversion unit 120) is 4:2:0 format. In the case of being 4:2:0 format, the processing proceeds to step S306, and if this is not the case, the processing proceeds to step S305.

At step S305, the intra prediction mode determination unit 104 updates the value of the weight coefficient for plane prediction to a larger value than the initial value set at step S301. As mentioned above, in plane prediction, a predicted image is generated by performing a computation using the values of a plurality of pixels adjacent to the block to be encoded for each pixel of the block to be encoded. Also, once the conversion from 4:2:2 format or 4:4:4 format to 4:2:0 format is performed, the data amount of the color difference components changes (in the example given in the present embodiment, the number of samples decreases). Thus, when plane prediction is performed on the moving image data converted from 4:2:2 or 4:4:4 format to 4:2:0 format, the accuracy of the predicted image drops. In view of this, in step S305, the intra prediction mode determination unit 104 increases the value of the weight coefficient for plane prediction, so that the plane prediction mode is less likely to be selected as the prediction mode for the color difference components. Note that the intra prediction mode determination unit 104 may be configured so as to increase the value of the weight coefficient not only for the plane prediction mode but for any prediction mode with respect to which the accuracy of the predicted image drops due to format conversion.

At step S306, the intra prediction mode determination unit 104 calculates a value obtained by multiplying the evaluation value of each intra prediction mode calculated at step S302 by the respective corresponding weight coefficient as a new evaluation value. The intra prediction mode determination unit 104 determines the intra prediction mode having the smallest evaluation value as the intra prediction mode to be used in encoding. The intra prediction mode determination unit 104 notifies the determined intra prediction mode to the intra/inter selection unit 105 for each of the luminance component and the color difference components.

The intra/inter selection unit 105 inputs the result of the motion search unit 103 and the result of the intra prediction mode determination unit 104, selects the prediction method having the smaller evaluation value, for example, and notifies the selected prediction method to the predicted image generation unit 106. The predicted image generation unit 106 generates a predicted image in accordance with the input prediction method, and outputs the generated predicted image to the subtractor 107. The predicted image generation unit 106 generates the predicted image from the image data of a reference frame acquired from the frame memory 102 in the case where inter prediction is selected, and generates the predicted image from a reconstructed image output by the adder 112 discussed later in the case where intra prediction is selected. The subtractor 107 computes the difference between the block to be encoded and the predicted image, and generates difference image data. The difference image data is output to the integer transform unit 108. The integer transform unit 108 performs an integer transform on the input difference image data, and the quantization unit 109 quantizes the transform coefficient obtained by the integer transform unit 108.

The entropy encoding unit 115 performs entropy encoding of the transform coefficient quantized by the quantization unit 109, and outputs the result to the recording unit 118 as a stream. Here, the quantization control unit 116 calculates the quantization coefficient of the quantization unit 109 from the code amount produced by the entropy encoding unit 115, a target code amount set by the code amount control unit 117, or the like. The recording unit 118 records the stream output from the entropy encoding unit 115 to the recording medium 119.

The transform coefficient quantized by the quantization unit 109 is also input to the inverse quantization unit 110. The inverse quantization unit 110 performs inverse quantization of the input transform coefficient, and the inverse integer transform unit 111 performs an inverse integer transform on the transform coefficient that was subject to inverse quantization.

The data obtained by the inverse integer transform unit 111 and the predicted image data generated by the predicted image generation unit 106 are input to the adder 112 and added. The added data, which is decoded reconstructed image data, is input to the predicted image generation unit 106 and used for generation of intra predicted image data. Also, the reconstructed image data is subject to encoding distortion reduction processing by the in-loop filter 113, and stored in an area for reference images in the frame memory 102 as reference image data to be used when inter encoding is performed.

According to the present embodiment, as described above, the image format conversion unit 120 converts a format relating to a ratio of the luminance component and the color difference components of moving image data acquired from the frame memory 102 into a format supported by the intra prediction mode determination unit 104.

It is thereby possible to configure a moving image encoding apparatus to support a plurality of image formats while suppressing an increase in circuit size.

### Second Embodiment

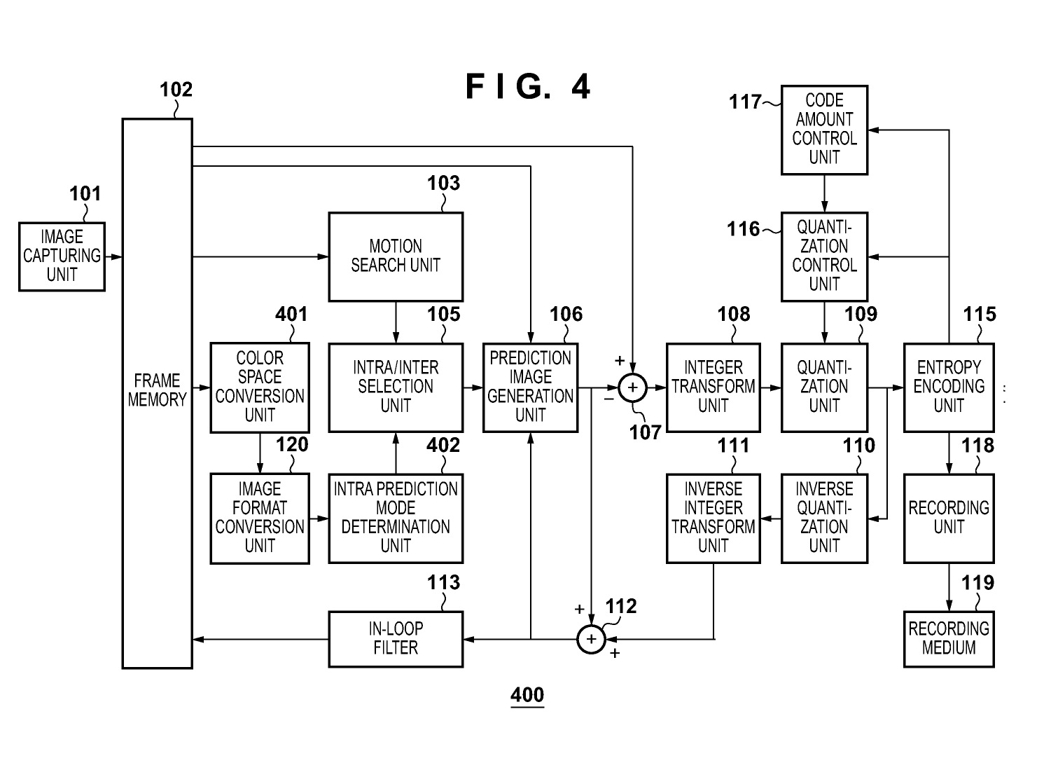

FIG. 4 is a block diagram showing a configuration of a moving image encoding apparatus 400 according to the second embodiment. In FIG. 4, constituent elements that are the same or similar to FIG. 1 are given the same reference signs as FIG. 1, and description thereof will be omitted. The moving image encoding apparatus 400 differs from the moving image encoding apparatus 100 in being provided with a color space conversion unit 401, as well as being provided with an intra prediction mode determination unit 402 instead of the intra prediction mode determination unit 104.

The moving image encoding apparatus 400 is also able to select a format whose R:G:B ratio is 4:4:4 as the image format of an image to be encoded, in addition to the three formats described in the first embodiment. Although the format whose R:G:B ratio is 4:4:4 is the same as the format whose Y:Cb:Cr is 4:4:4 in terms of the three color components (R, G, B) having the same number of samples, the color spaces differ.

The intra prediction mode determination unit 402 supports only moving image data in the format whose Y:Cb:Cr ratio is 4:2:0. Accordingly, when the format whose R:G:B ratio is 4:4:4 is selected, the color space of the format supported by the intra prediction mode determination unit 402 differs from the color space of the format of the image to be encoded (moving image data stored in frame memory 102).

The color space conversion unit 401 converts the image data of the block to be encoded that is stored in the frame memory 102 into the color space (i.e., YCbCr color space) of the format supported by the intra prediction mode determination unit 402, and supplies the converted image data to the image format conversion unit 120. The color space conversion unit 401 also performs similar processing on neighboring image data of the block to be encoded. Accordingly, image data in the supported format having the supported color space is input to the intra prediction mode determination unit 402.

The color space conversion unit 401 executes conversion from RGB color space to YCbCr color space in accordance with the following equations. Y, Cb, and Cr are calculated by computing

Y=0.2126×R+0.7152×G+0.0722×B

Cb=0.5389(B−Y)

Cr=0.6350(R−Y)

where R, G, and B are respectively the pixel values of the R component, the G component and the B component, and Y, Cb and Cr are respectively the pixel values of the Y component, the Cb component and the Cr component. Note that the conversion equations are not limited to the abovementioned equations.

The intra prediction mode determination unit 402 determines the intra prediction mode for each of the luminance component and the color difference components, based on the input image data in the format whose of Y:Cb:Cr ratio is 4:2:0, similarly to the first embodiment. The intra prediction mode determination unit 402 then selects the intra prediction mode determined for the luminance component as the intra prediction mode for the G component, and selects the intra prediction mode determined for the color difference components as a common intra prediction mode for the B component and the R component. Alternatively, the intra prediction mode determination unit 402 may select the intra prediction mode determined for the luminance component as a common intra prediction mode for the R component, the G component and the B component. The intra prediction mode determination unit 402 then notifies the selected intra prediction mode(s) to the intra/inter selection unit 105.

According to the present embodiment, as described above, the color space conversion unit 401 converts the color space of moving image data acquired from the frame memory 102 into the color space of a format supported by the intra prediction mode determination unit 402. The intra prediction mode determination unit 402 selects the intra prediction mode for each component of the color space of the moving image data stored in the frame memory 102 from among the intra prediction modes determined based on the image data in the format supported by the intra prediction mode determination unit 402.

It is thereby possible to configure a moving image encoding apparatus to support a plurality of image formats having different color spaces while suppressing an increase in circuit size.

### Other Embodiments

Aspects of the present invention can also be realized by a computer of a system or apparatus (or devices such as a CPU or MPU) that reads out and executes a program recorded on a memory apparatus to perform the functions of the above-described embodiment(s), and by a method, the steps of which are performed by a computer of a system or apparatus by, for example, reading out and executing a program recorded on a memory apparatus to perform the functions of the above-described embodiment(s). For this purpose, the program is provided to the computer for example via a network or from a recording medium of various types serving as the memory apparatus (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-241104, filed on Oct. 31, 2012, which is hereby incorporated by reference herein in its entirety.

What is claimed is:

1. A moving image encoding apparatus that supports a plurality of image formats, comprising:
a memory unit configured to temporarily store moving image data;
a format conversion unit configured to convert a format of moving image data acquired from the memory unit, the format relating to a ratio of a luminance component and color difference components;
a determination unit configured to determine a prediction mode of intra-frame prediction encoding based on the converted moving image data; and
an encoding unit configured to perform intra-frame prediction encoding on the moving image data acquired from the memory unit using the determined prediction mode,
wherein the determination unit supports moving image data in a predetermined format having a predetermined ratio of the luminance component and the color difference components, and
the format conversion unit, when the format of the moving image data acquired from the memory unit differs from the predetermined format, converts the format of the moving image data acquired from the memory unit into the predetermined format.

2. The moving image encoding apparatus according to claim 1,
wherein the determination unit calculates an evaluation value representing a correlation between a block to be encoded and a predicted image for each of a plurality of prediction modes including a predetermined prediction mode, and selects one of the plurality of prediction modes based on the evaluation values,
the predetermined prediction mode is a prediction mode for generating a predicted image, by performing prediction for each pixel of the block to be encoded using values of a plurality of pixels adjacent to the block to be encoded, and
the determination unit weights the evaluation values, so that the predetermined prediction mode is less likely to be selected as the prediction mode for a component whose data amount changes as a result of conversion by the format conversion unit, compared with a case where the data amount does not change.

3. The moving image encoding apparatus according to claim 2, wherein the predetermined prediction mode is a prediction mode for performing plane prediction.

4. The moving image encoding apparatus according to claim 1,
wherein the format of the moving image data stored in the memory unit is one of a format whose Y:Cb:Cr ratio is 4:4:4, a format whose Y:Cb:Cr ratio is 4:2:2, and a format whose Y:Cb:Cr ratio is 4:2:0, and
the predetermined format is the format whose Y:Cb:Cr ratio is 4:2:0.

5. The moving image encoding apparatus according to claim 1,
wherein the format of the moving image data stored in the memory unit is one of a format whose Y:Cb:Cr ratio is 4:4:4, a format whose Y:Cb:Cr ratio is 4:2:2, and a format whose Y:Cb:Cr ratio is 4:2:0, and the predetermined format is the format whose Y:Cb:Cr ratio is 4:2:2.

6. The moving image encoding apparatus according to claim 1,
wherein the determination unit supports moving image data in a format whose Y:Cb:Cr ratio is 4:2:0 as the predetermined format, and
the format conversion unit, when the moving image data acquired from the memory unit is in a format whose Y:Cb:Cr ratio is one of 4:4:4 and 4:2:2, converts the format of the moving image data acquired from the memory unit into the format whose Y:Cb:Cr ratio is 4:2:0.

7. The moving image encoding apparatus according to claim 1,
wherein the determination unit supports moving image data in a format whose Y:Cb:Cr ratio is 4:2:2 as the predetermined format, and
the format conversion unit, when the moving image data acquired from the memory unit is in a format whose Y:Cb:Cr ratio is one of 4:4:4 and 4:2:0, converts the format of the moving image data acquired from the memory unit into the format whose Y:Cb:Cr is 4:2:2.

8. The moving image encoding apparatus according to claim 1, further comprising a color space conversion unit configured to, when a color space of the moving image data stored in the memory unit differs from a color space of the predetermined format, convert the color space of the moving image data into the color space of the predetermined format.

9. The moving image encoding apparatus according to claim 8, wherein the color space of the predetermined format is YCbCr color space.

10. The moving image encoding apparatus according to claim 8, wherein the color space of the moving image data stored in the memory unit is RGB color space.

11. The moving image encoding apparatus according to claim 8, wherein, when the predetermined format is a format whose Y:Cb:Cr ratio is 4:2:0 and the moving image data acquired from the memory unit is in a format whose color space is RGB color space, the color space conversion unit converts the color space of the moving image data acquired from the memory unit into YCbCr color space, and the format conversion unit converts the moving image data converted into the YCbCr color space into the format whose Y:Cb:Cr ratio is 4:2:0.

12. The moving image encoding apparatus according to claim 1, wherein the moving image encoding apparatus is configured so as to enable a user to select the format of moving image data to be encoded that is acquired from the memory unit.

13. An image capturing apparatus comprising:
an image capturing unit configured to generate moving image data; and
the moving image encoding apparatus according to claim 1.

14. A method of controlling a moving image encoding apparatus that supports a plurality of image formats and has a memory unit configured to temporarily store moving image data, comprising:
a format conversion step of converting a format of moving image data acquired from the memory unit, the format relating to a ratio of a luminance component and color difference components;
a determination step of determining a prediction mode of intra-frame prediction encoding based on the converted moving image data; and
an encoding step of performing intra-frame prediction encoding on the moving image data acquired from the memory unit using the determined prediction mode,
wherein the determination step supports moving image data in a predetermined format having a predetermined ratio of the luminance component and the color difference components, and
in the format conversion step, when the format of the moving image data acquired from the memory unit differs from the predetermined format, the format of the moving image data acquired from the memory unit is converted into the predetermined format.

15. A computer-readable storage medium in which a program is stored, the program being for causing a computer to execute the method according to claim 14.
